(19) United States
(12) Patent Application Publication
(10) Pub. No.: US 2008/0166598 A1
(43) Pub. Date: Jul. 10, 2008

(54) Arrangement for Compressing Fuel Cells in a Fuel Stack

(75) Inventor: Timo Mahlanen, Helsinki (FI)

Correspondence Address: SMITH-HILL AND BEDELL, P.C., 16100 NW CORNELL ROAD, SUITE 220, BEAVERTON, OR, 97006, US

(73) Assignee: WARTSILA FINLAND OY, Vaasa (FI)

(21) Appl. No.: 11/813,195

(22) PCT Filed: Jan. 2, 2006
(86) PCT No.: PCT/FI2006/050003

§ 371 Date: Jun. 29, 2007

(30) Foreign Application Priority Data
Jan. 13, 2005 (FI) 20055017

(51) Int. Cl. H01M 8/24; H01M 8/02; F16F 13/00

(52) U.S. Cl. 429/12; 267/103

(57) ABSTRACT

Element for compressing a fuel cell stack comprising two spring plates defining a gas-tight cavity filled with a suitable medium. Expansion of the medium upon increase of the temperature gives rise to a force compressing the stack. Additional spring rings can be placed between the spring plates, in order to increase the compressive force.

The present invention relates to an arrangement for compressing fuel cells in a fuel cell stack as described in the preamble of claim 1.

A fuel cell is an apparatus by means of which fuel can be transformed directly into electricity via a chemical reaction. Hydrogen can be used as fuel, in some cases a mixture of hydrogen and carbon monoxide can also be used. Some fuel cell types are capable of so-called internal reforming, whereby also methane or methanol can be used as fuel. For the reaction, oxygen is also needed, and it is usually conveyed to the fuel cell in the form of air. The fuel cell includes an anode and a cathode, with electrolyte therebetween. Both the anode and cathode contain a catalyst for easing the chemical reactions. The electrolyte prevents direct mixing and combustion of fuel and oxidizer, but it allows a certain ion to pass through. A fuel cell does not have to be charged like a battery. Instead, it works as long as fuel and oxidizer are introduced thereto.

The advantages of fuel cells include good efficiency, silence and very small need of moving parts. For example, in fuel cells operating in so-called free convection mode there is no need for moving parts. Another advantage is that being only water or water vapour, the emissions are environmentally friendly and clean.

Fuel cell systems, which can comprise, e.g. solid oxide fuel cells (SOFC) or molten carbonate fuel cells (MCFC) or other suitable fuel cell types, include a number of single planar fuel cells located one on top of the other and they are insulated from each other by means of ceramic seals. Fuel cells and seals are tightly pressed against each other by means of tightening nuts and drawbars. Single fuel cells thus form a fuel cell stack, a number of which can further be connected in series or in parallel for further increasing voltage or current. An arrangement, in which a number of fuel cell stacks connected to each other are fastened to a substrate, via which the fuel inlet and exhaust gas outlet needed by the fuel cells are carried out, is called, for example, a fuel cell unit.

In practice, one of the problems of fuel cells is keeping the fuel cell stacks sealed and in even compression as the temperature of the fuel cell unit increases or fluctuates. A commonly used technique is the above-mentioned compressing of the fuel cells between bolts or drawbars. Because the temperature of the fuel cell stack will rise to a rather high level, compression springs are needed in one end of the drawbars in order to avoid the reducing of the compression force acting on the fuel cells due to the thermal expansion of the drawbars. As the fuel cells are in a high temperature, in an isolated space, the springs will have to be located outside the isolation due to temperature, because a spring will not operate as needed in high temperatures. In fuel cell systems the operation temperatures of fuel cells can increase to temperatures in excess of 750° C. However, springs located outside the isolation cause heat loss, which will in practice be excessive or it will at least decrease the efficiency of the fuel cells. Further, springs located outside the isolation, in the ends of the fuel cell stacks, increase the space requirement for the fuel cell unit.

An attempt to correct these problems is described, e.g. in European patent application EP 1416569 A2, which describes a solution for maintaining the compression tension as the temperature of the fuel cell stack increases. In this solution the mechanical springs are replaced by a gas-filled cushion that expands and thereby increases the compression of the fuel cell stack as the temperature increases. A gas-filled cushion alone, however, is not sufficient, because even in installation temperature, normally an approximately normal room temperature, the fuel cell stack must be compressed with a force of about 300-500 kg for achieving the necessary degree of sealing. If this compression force is created by means of the gas pressure of the cushion only, the gas pressure inside the cushion will increase to about threefold, with the volume of the cushion being the same, as the fuel cell stack reaches its operation temperature, i.e. about +750° C. or even more. Thus, if the pre-tightening pressure in room temperature is, for example, 6 bar, during operational situation the cushion must withstand a pressure of about 18 bar.

Further, the weld seams of the gas cushion are a problem with the invention according to the European patent application, the seams being subject to very large tensions and therefore prone to breakages.

The aim of the present invention is to eliminate the above-mentioned disadvantages and to accomplish as reliable a method and apparatus as possible for compressing a fuel cell stack so that the compression force of the fuel cell stack stays even and the degree of sealing of the fuel cell stack remains as good as possible in demanding, high and changing temperatures during the operation of the fuel cell apparatus. The arrangement according to the invention is characterized by what is disclosed in the characterizing part of claim 1. Other embodiments of the invention are characterized by what is disclosed in other claims.

The basic idea of a solution according to the invention is that fuel cell stacks are compressed by means of a spring means causing an even compression on the whole area of the fuel cell stack. Thus, the fuel cell stack is provided with one or more single spring means for directing to the fuel cells of the fuel cell stack both a mechanical spring force and a compression force caused by the medium as the temperature increases. The spring means comprises two spring plates arranged against each other for directing a mechanical spring force to the fuel cells of the fuel cell stack. A space filled with a medium is located between the spring plates. As the temperature increases, the pressure of the medium increases, whereby the spring means directs a compression force to the fuel cells of the fuel cell stack.

An advantage of an arrangement according to the invention is that the arrangement needed for compressing the fuel cell stack is small in size, does not cause extra heat losses and is more reliable in use than prior art and is also easier to manufacture. Another advantage is that due to the design the stresses affecting the weld seam of the spring means are small, whereby the spring means has a long service life. Another advantage of the arrangement is that due to its shape the spring means is centred in the space arranged for it, whereby the compression force is always even and installation is simple. Yet another advantage is that in the low temperatures of the installation phase the spring means acts like a normal diaphragm spring, causing the necessary pre-tightening of the fuel cell stack. Correspondingly, in the operation temperature of the fuel cells, as the length of the drawbars and the fuel cell stack increases due to thermal expansion, the pressure of the medium between the spring plates increases and its length along its longitudinal axis increases, i.e. the distance between the spring plates increases, whereby the spring means compresses the fuel cell stack with an increasing force, thereby compensating for the thermal expansion of the drawbars, and keeps the fuel cell stacks sealed. A further advantage is that even if the fuel cell stack is shutdown and allowed to cool and then started again, thereby heating, the mechanical spring property and the gas spring property of the spring means keeps the fuel cell stack constantly sealed.

In the following the invention is disclosed in more detail by means of an exemplary embodiment and by reference to the appended drawings, in which

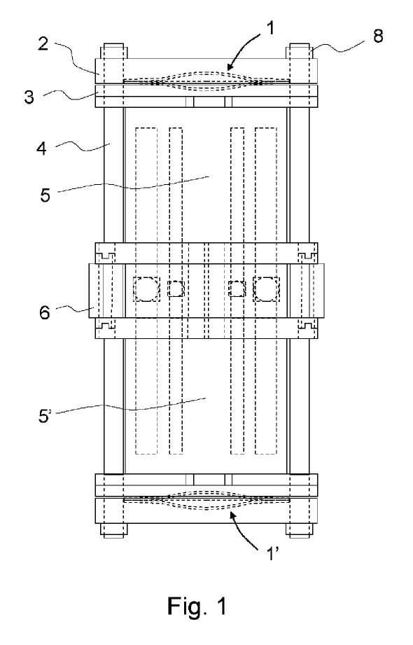

FIG. 1 illustrates one embodiment of a compression arrangement for fuel cell stacks seen from the side,

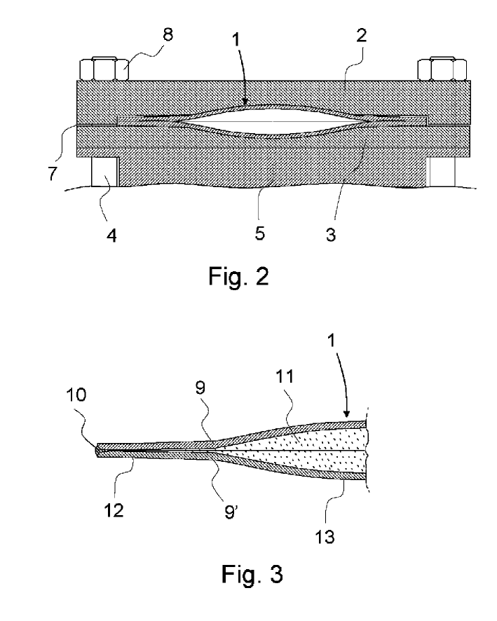

FIG. 2 illustrates as a cross-sectional view the end of the fuel cell stack of FIG. 1,

FIG. 3 illustrates the design of the spherical spring means used in the compression arrangement of FIG. 1 in a simplified, partial cross-section,

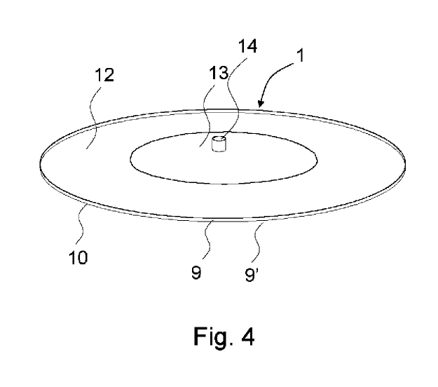

FIG. 4 illustrates the spherical spring means used in the compression arrangement of FIG. 1 as a three-dimensional projection figure seen from above at an angle,

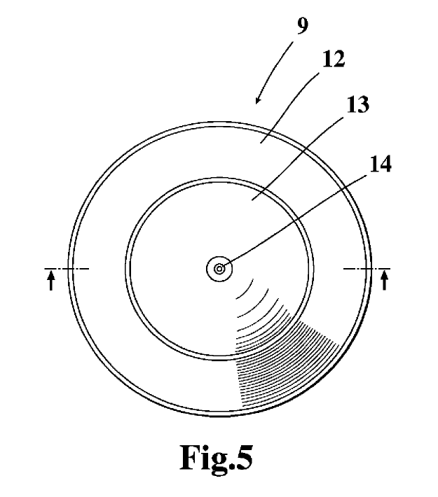

FIG. 5 illustrates another spring means from above, which spring means can be used in a fuel cell stack compression arrangement according to FIG. 1,

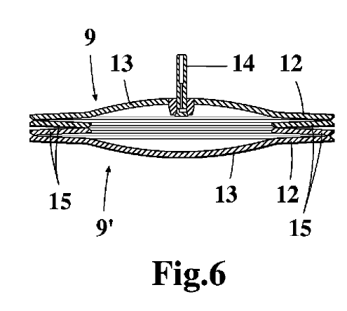

FIG. 6 illustrates, in cross-section, the spring means of FIG. 5.

FIG. 1 shows, as a simplified schematic illustration, a typical stack design of fuel cells in a fuel cell apparatus, in which the arrangement according to the invention can be used. FIG. 1 illustrates a solution, in which the fuel cell stacks 5 and 5′ are fastened and tightened by means of drawbars 4 located in essentially oversized installation holes and tightening nuts acting as tightening means 8 to a connector piece located between the fuel cell stacks and acting as a substrate 6. The connector piece includes, among others, the inlet and exhaust channels for the gases of the anode and cathode sides of the fuel cells. Spherical spring means 1 and 1′ are located in the outer ends of the fuel cell stacks 5 and 5′ between an upper pressure plate 2 and a lower pressure plate 3 so that the spring means 1 and 1′ press the fuel cell stacks 5 and 5′ against the external substrate 6.

FIG. 2 illustrates as a cross-sectional view the location of the spherical spring means 1 in the outer end of the fuel cell stack 5. The spring means 1 is installed between pressure plates 2 and 3, the mating surfaces of the pressure plates being shaped to correspond to the spherical shape of the spring means 1 and the shape of the collar-like edge. Both pressure plates 2 and 3 therefore have a spherical cavity corresponding to the spherical surface of the spring means 1. At least one of the pressure plates 2 additionally has a cavity corresponding to the shape of the collar of the spring means. Thus, the essentially spherical outer surface of the spring means 1 accurately centres the spring means 1 in its place, whereby the compression of the spring means 1 is evenly divided on the fuel cell stack 5 and installation is easy as well.

The spherical spring means 1 keeps the distance between the pressure plates 2 and 3 by its spring force and because the tightening means 8, i.e. the tightening nuts keep the upper pressure plate 2 in its place, the lower pressure plate 3 compresses the fuel cell stack 5 evenly downwards against the substrate 6. The cavities of the pressure plates 2 and 3 are dimensioned so in relation to the spring means 1 that in room temperature, in which the installation of the fuel cell apparatus is carried out, subsequent to the tightening of the drawbars 4 the spring means 1 compresses the pressure plate 3 like a mechanical spring, such as a diaphragm spring or a leaf spring, and thereby it also presses the fuel cell stack 5 against the substrate 6 with a force of about 300-500 kg, i.e. about 3-5 kN, thereby causing a sufficient pre-tightening for the fuel cell stack 5. As the temperature increases to the operation temperature of the fuel cells, i.e. to about +750° C. or more, the gas 11 inside the spring means 1 expands causing an increasing compressing force, thereby compensating for the lengthening of the drawbars 4 due to the thermal expansion. In the operation temperature of the fuel cells the compression force of the spring means 1 can be between 300 and 1200 kg, i.e. about 3-12 kN, most preferably the compression force is between 500 and 700 kg, i.e. about 5-7 kN.

The drawbars 4 can move in their installation holes in pressure plates 2 and 3 as well as, in this embodiment, freely through the substrate 6 in the direction of their longitudinal axis. The fuel cell stack 5 is compressed against the substrate 6 by means of drawbars 4 and tightening nuts. The spherical spring means 1 is dimensioned so that when the spring means 1 is assembled between the upper pressure plate 2 and the lower pressure plate 3, a clearance 7 is formed between the pressure plates at the edges of the pressure plates 2 and 3. As the compression force of the spring means 1 increases due to the increase of temperature and as the length of the drawbars 4 increases due to thermal expansion, the clearance 7 between the pressure plates 2 and 3 increases.

FIG. 3 illustrates the design of the spherical spring means 1 in more detail and as a partial cross-sectional view. The spring means 1 consists of two round and disc-like spring plates 9 and 9′ arranged against each other, the plates being similar and being made of suitable steel or other metal. A so-called essentially spherical cup portion 13 is pressed in the centre of each plate and the edge of the cup part is formed as an inclined collar 12 enveloping the cup portion. The spring plates 9 and 9′ are positioned against each other and welded air-tightly to each other along the whole periphery of the circular collar. The tensions caused to the weld seam 10 stay small when the inclined collar 12 of the spring means 1 is suitably dimensioned both regarding the inclination and the diameter of the collar. Thus, the spring plates 9 and 9′ are essentially fastened to each other along their outer peripheries and when moving towards the centre of the spring means 1 the spring plates 9 and 9′ become more distant from each other the closer to the centre axis of the spring means one is, until the collar part is united with the essentially spherical cup portion 13 of the spring means, where increase of distance becomes greater. The inclination of the collar 12 in radial direction is suitably between 1:10 and 1:100, preferably for example 1:50. By means of a suitable inclination the collar 12 can also produce a mechanical effect, such as that produced by a diaphragm spring, i.e. the collars 12 form a mechanical spring directing a mechanical spring force to the fuel cells of the fuel cell stacks via the cup portion 13. Correspondingly, the relation of the width of the collar to the diameter of the spring means 1 can, for example, be from 1:3 to 1:6, suitably the relation can, for example, be 1:4 to 1:5, and preferably for example 1:4.8.

The outer surface of the cup portion 13 in the centre of the spring means 1 is essentially in the form of a spherical surface on both sides of the spring means so that in cross-section the thickest part of the spring means is in the centre axis of the spring means and the spring means becomes thinner towards the edge. The cup-like portion 13 forms a hollow space within the spring means, the space being filled with a suitable medium, such as gas 11, the pressure of which increases as the temperature increases and decreases as the temperature decreases. Thus, the length of the spring means, i.e. the distance between the opposite spring plates 9, 9′ tends to accordingly change according to the temperature. Therefore, as the temperature increases, the compression force created by the spring means 1 increases and accordingly decreases, as the temperature decreases. The gas 11 inside the spring means 1 is preferably e.g. an inert gas that is chemically non-reagent and stable. In the low temperatures of the installation phase the spring means 1′ therefore acts as a mechanical spring, creating the necessary pre-tightening for the fuel cell stack. The pressure of the gas inside the spring means 1 is in room temperature only e.g. about 1 to 4 bar, for example preferably 1.5 bar. Correspondingly, in the operation temperature of the fuel cells the pressure of the gas increases to about 3 to 12 bar, e.g. preferably to about 4.5 bar. When the fuel cell is occasionally shutdown and cooled and again started up and heated, the mechanical spring property and the gas spring property of the spring means 1 keep the fuel cell stack continuously sealed. FIG. 4 also illustrates a valve 14 arranged in connection with the spring means 1, by means of which the amount of gas inside the spring means 1 can be increased or decreased or the gas can even be replaced by another gas.

FIGS. 5 and 6 show another spherical spring means 1′ that can be used in a compression arrangement of a fuel cell stack as shown in FIG. 1. The spring means 1 comprises two similar plate-like spring plates 9 and 9′ arranged against each other. The spring plates 9, 9′ are circular. The spring plates are made of a steel or other metal suitable for the purpose. Suitable materials include heat-resistant metal alloys, such as nickel-based alloys, for example Inconell (Ni—Cr—Fe alloy) or Haynes 230 (Ni—Cr—W—Mo alloy). In the centre of each spring plate 9, 9′ is a spherical cup portion 13. The edge of the cup portion 13 is formed so as to be an inclined collar 12 encircling the cup portion 13. The collars 12 provide the necessary mechanical diaphragm spring effect, i.e. the collars 12 form a mechanical spring directing a mechanical spring force to the fuel cells of the fuel cell stack.

A spring assembly is located between the collars 12 of the spring plates 9, 9′, by means of which the mechanical force directed to the fuel cell stacks by the spring means 1′ is increased. The spring assembly comprises two spring rings 15 arranged against each other. The spring rings 15 are annular. The spring rings 15 are gas-tightly fastened to each other by their inner edges by means of, for example, welding. The outer periphery of each spring ring 15 is gas-tightly fastened to the outer periphery of each opposite collar 12 by means of, for example, welding. The inner peripheries of the spring rings 15 are fastened to each other and the spring rings 15 become separated from each other towards the outer periphery. Accordingly, the outer peripheries of the spring rings 15 are fastened to the collars 12 and towards the inner periphery the spring rings become separated from collars 12. The collars 12 and the spring rings 15 form a mechanical spring that directs in installation temperature a mechanical spring force to the fuel cells of the fuel cell stack via the cup portion 13. The strength of the mechanical spring force depends on the inclination of the collars 12 and the spring rings 15. Typically the inclination of the collars and the spring rings in the direction of the radius is 1: 15-1:35. The relation between the width of the collars 12 and the spring rings 15 to the diameter of the whole spring means is between 1:2.5 and 1:35, typically about 1:2.8. In addition, the strength of the mechanical spring force depends on the thickness of the spring plates 9, 9′. The compression force created by the gas inside the spring means 1′ depends, in addition to the gas pressure, the thickness of the spring plates 9, 9′. The thickness of the spring plates 9, 9′ and the spring rings 15 is 1.5 to 3 mm, typically about 2 mm. The mechanical compression force of the spring means 1′ can further be increased by arranging, for example, four stacked spring rings 15 between the collars 12.

The outer surface of the cup portion 13 in the centre of the spring means 1′ is essentially in the form of a spherical surface on both sides of the spring means so that in cross-section the thickest part of the spring means is in the centre axis of the spring means and the spring means becomes thinner towards the edge. The cup-like portion 13 forms a hollow space within the spring means 1′, the space being filled with a suitable medium, such as gas 11, the pressure of which increases as the temperature increases and decreases as the temperature decreases. Thus, the length of the spring means, i.e. the distance between the spring plates 9, 9′ accordingly changes along with the temperature at the cup portion 13. The distance between the opposite spring plates 9, 9′ increases as the pressure of the gas 11 increases and reduces as the pressure of the gas decreases. The gas 11 inside the spring means 1′ is preferably an inert gas, for example, the gas being chemically non-reagent and stable. In the low temperatures of the installation phase the spring means 1 acts as a mechanical spring, creating the necessary pre-tightening for the fuel cell stack. The pressure of the gas inside the spring means 1′ is, in room temperature, e.g. about 1 to 4 bar, for example preferably 1.5 bar. Correspondingly, in the operation temperature the pressure of the gas increases to about 3 to 12 bar, preferably to about 4.5 bar. As the temperature increases, the mechanical spring force directed by the spring means 1′ to the fuel cells of the fuel cell stack is decreased and the compression force caused by the gas between the spring plates 9, 9′ increases. Accordingly, as the temperature is reduced, the mechanical spring force is increased and the compression force caused by the gas is decreased. When the fuel cell is occasionally shutdown and cools, and again started up and heated, the mechanical spring property and the gas spring property of the spring means 1′ keep the fuel cell stack continuously sealed. FIGS. 5 and 6 also illustrates a valve 14 arranged in connection with the spring means 1′, by means of which the amount of gas inside the spring means 1′ can be increased or decreased or the gas can even be replaced by another gas.

It is obvious to one skilled in the art that the invention is not limited to the above-mentioned examples, but it can be varied within the following claims. So, more than one spherical spring means 1, 1′ can be used for compressing one fuel cell stack 5. Also, the components, materials, shapes and dimensions used can differ from that described above as long as they are dimensioned and designed so as to achieve the result according to the invention.

It is also obvious to one skilled in the art that when seen from above, the spring means can have another shape instead of circular, such as elliptical, square or rectangular. In this case the spring rings 15 of the embodiment according to FIGS. 5 and 6 have the same shape as the spring means.

It is also obvious to one skilled in the art that the solution according to the invention can be used as a spring solution for other applications than those described above.

It is further obvious to one skilled in the art that in addition to the combined mechanical spring and the gas or liquid spring expanding with the increase of temperature also separate mechanical springs and gas or liquid springs can be used together. In this case the inside shape between the pressure plates 2 and 3 is formed such that one or more mechanical springs, for example helical springs, diaphragm springs or disc springs can be arranged between the compression plates 2 and 3, the springs creating the necessary pre-tightening, and in addition to mechanical springs, one or more expanding cushions or the like, filled with a medium expanding as the temperature increases, such as a gas or a liquid, the cushion withstanding high temperatures and creating the necessary compression as the length of the drawbars increases due to thermal expansion.

The mechanical spring force is wholly or mainly created by means of the mechanical design of the spring. Accordingly, in the gas spring the spring force is wholly or mainly created by means of the pressure of the gas inside the spring.

1-10. (canceled)

11. An arrangement for compressing fuel cells in a fuel cell stack, in which arrangement the compression of fuel cells of the fuel cell stack against each other and the substrate is carried out by means of at least spring force, the fuel cell stack being provided with one or more single spring means for directing mechanical spring force and as the temperature increases, the compression force created by medium of the spring means to the fuel cells of the fuel cell stack, the spring means comprising two spring plates facing each other, and wherein a space between the spring plates is filled with said medium, wherein said spring plates form a mechanical spring for directing mechanical spring force to the fuel cells of the fuel cell stack.

12. An arrangement according to claim 11, wherein the edge portions of the spring plates are formed by collars, the collars being inclined towards each other so that the collars are touching each other at the outer edge of the spring means and they become evenly separated from each other towards the centre of the spring means.

13. An arrangement according to claim 11, wherein the edge portions of the spring plates are formed by collars, the collars being inclined towards each other and having a mechanical spring assembly arranged between them.

14. An arrangement according to claim 13, wherein the spring assembly comprises two spring rings arranged against each other, the inner edges of which are fastened to each other and the outer edges of which are fastened to the collars.

15. An arrangement according to claim 11, wherein in the centre of the spring means there is a hollow cup portion shaped like a spherical surface and filled with a suitable medium, such as gas.

16. An arrangement according to claim 11, wherein the spring means is arranged to operate as both a mechanical spring and as the temperature increases, as a gas spring.

17. An arrangement according to claim 11, wherein the mechanical compression force of the spring means is created by means of the collars or the collars and a spring assembly between the collars and the compression force of the medium is created by means of a medium in space.

18. An arrangement according to claim 11, wherein in order to compress the fuel cell stack the arrangement comprises drawbars with their tightening means and that the outer end of the fuel cell stack comprises a lower pressure plate and an upper pressure plate having installation holes for the drawbars and a cavity essentially corresponding to the shape of the spring means, with the spring means being arranged between the pressure plates so that as the pressure plates are in a pre-tightened state there is a clearance between the pressure plates.

19. An arrangement according to claim 11, wherein the spring means is provided with a valve for increasing or decreasing the amount of gas or replacing the gas inside the spring means.

20. An arrangement according to claim 11, wherein the thickness of the spring plates is 1.5-3 mm.

21. A fuel cell stack comprising:
a plurality of fuel cells,
a substrate, and
a spring structure for compressing the fuel cells against each other and against the substrate,
wherein the spring structure comprises two dished spring plates that generate a mechanical spring force,
and wherein the spring plates are concave towards each other and are sealed to each other to define a cavity therebetween, said cavity containing a thermally expansible fluid under pressure whereby at increasing temperature the pressure in the cavity increases and the spring structure generates a force for compressing the fuel cells.

22. A fuel cell stack according to claim 21, wherein the spring structure is circular and has an outer periphery and a center, each of the spring plates has a peripheral collar, and the peripheral collars of the two spring plates are inclined to each other so that the collars are in contact at the outer periphery of the spring structure and diverge from each other towards the center of the spring structure.

23. A fuel cell stack according to claim 21, wherein each of the spring plates has a peripheral collar and the spring structure further comprises a mechanical spring assembly between the collars of the spring plates.

24. A fuel cell stack according to claim 23, wherein the mechanical spring assembly comprises two spring rings each having an inner edge and an outer edge, the inner edges of the two spring rings are fastened to each other and the outer edges of the two spring rings are fastened to the collars respectively.

25. A fuel cell stack according to claim 24, wherein the spring structure is circular and has an outer periphery and a center, the peripheral collars of the two spring plates are inclined to each other so that the collars diverge from each other from the outer periphery of the spring structure towards the center of the spring structure, and the two spring rings diverge from each other from the inner edges of the spring rings toward the outer edges of the spring rings.

26. A fuel cell stack according to claim 21, wherein the dished spring plates are substantially spherically concave towards each other and said cavity.

27. A fuel cell stack according to claim 21, wherein the thermally expansible fluid is a gas.

28. A fuel cell stack according to claim 21, wherein the spring structure includes a valve for introducing expansible fluid into said cavity or removing expansible fluid from the cavity.

29. A fuel cell stack according to claim 21, wherein the spring plates are 1.5-3 mm in thickness.

30. A fuel cell stack according to claim 21, comprising outer and inner pressure plates, drawbars attached to the substrate and extending through installation holes in the pressure plates, and tightening means engaging the drawbars for urging the outer pressure plate towards the substrate,
and wherein the inner pressure plate is between the outer pressure plate and the substrate, the fuel cells are located between the inner pressure plate and the substrate, the outer and inner pressure plates are formed with confronting recesses in which the spring structure is received, and there is a clearance between the pressure plates.
